(19) United States
(12) Patent Application Publication
(10) Pub. No.: US 2024/0228341 A1
(43) Pub. Date: Jul. 11, 2024

(54) METHOD FOR REMOVAL OF HUMIC ACID FROM WATER

(71) Applicant: Anhui University of Technology, Maanshan (CN)

(72) Inventors: Lei Ding, Maanshan (CN); Yan Li, Maanshan (CN); Jiangya Ma, Maanshan (CN); Huiwen Zhang, Maanshan (CN); Yanli Kong, Maanshan (CN)

(21) Appl. No.: 18/403,186

(22) Filed: Jan. 3, 2024

(30) Foreign Application Priority Data
Jan. 10, 2023 (CN) 2023100378419

(51) Int. Cl. C02F 1/72; C02F 1/30; C02F 1/32; C02F 1/42; C02F 1/48; C02F 101/34; C02F 103/06

(52) U.S. Cl. CPC C02F 1/722; C02F 1/30; C02F 1/32; C02F 1/42; C02F 1/48; C02F 2001/422; C02F 2101/34; C02F 2103/06; C02F 2303/04; C02F 2305/023

(57) ABSTRACT

A method for a removal of HA from water is provided, including using PMS as an oxidant, using VI or UV as an activation source, and adding a MIEX resin into the water for a reaction. By applying the method, irradiated by the visible light, a VI/MIEX/PMS system is coupling to strengthen adsorption process, thereby realizing a relatively high removal effect on the HA; therefore, the VI/MIEX/PMS system can be suitable for a large-scale environment performed by water treatment, and a removal efficiency thereof on HA can reach 60% or above. Moreover, irradiated by the ultraviolet light, a UV/MIEX/PMS system can be suitable for small and medium-sized environment performed by rapid water treatment, and can cope with sudden HA pollution of water source in a medium and small range, and a removal efficiency thereof on HA can reach 90% or above.

### TECHNICAL FIELD

The disclosure relates to the technical field of water treatment, particularly to a method for a removal of humic acid from water.

### BACKGROUND

Water resources are the foundation of human survival, and water pollution is one of major sanitary crises to be solved urgently at present.

With the acceleration of industrialization and agricultural industrialization, untreated organic wastewater has been discharged in large quantities, resulting in serious pollution of surface and ground water, which has severely threatened human and animal health. The removal of natural organic matter, such as humic acid (HA), has become a basic problem in the treatment of drinking water. The natural organic matters (NOM) can not only lead to changes in water quality of a natural water body, but also cause damage to water environment of the natural water body.

Researchers have found that the HA not only has biologic toxicity, but also combines with other substances to cause a series of water resource problems. However, the current processes are difficult for the efficient removal of the HA and are prone to secondary pollution such as excessive coagulants, disinfectants, and disinfection by-products. Liu Yang used ozone-activated carbon (O₃-AC) process to remove 31.92% of dissolved organic carbon (DOC) in Taihu Lake. The natural organic matters in the Yellow River were treated separately using the ozone, and the removal effect of which only reached 16.6%. The removal effect of NOM is not ideal either by individual oxidation or by commonly used coupling processes. This is because the HA is natural polymer organic matters, a molecular weight distribution of which is extremely wide, and it is difficult to use a separate removal process to achieve a better removal effect. However, advanced oxidation technology can enable the HA to be converted into matters from macromolecules into small molecules, and then adsorbed and removed by an adsorbent. Potassium peroxymonosulfate (PMS) is a kind of peroxyate with strong oxidizing properties. However, due to toxicity of oxidation by-products and catalysts, oxidation of the conventional peroxyate is rarely used in drinking water treatment. Therefore, it is extremely necessary to seek new, efficient, and green peroxyate processes to remove the natural organic matters such as HA from the water sources and ensure the safety of drinking water quality.

At present, the water qualities of water sources are different; there are water treatments for a small-range rural water source and a small water plant, as well as for a large reservoir and a water plant. However, there are few green methods for water treatment specifically designed for different water source environments with simple operation and better removal effect.

### SUMMARY

In view of the above problems, an objective of the disclosure is to provide a method for a removal of humic acid from water, which can efficiently remove the humic acid from the water and is suitable for water sources with different water qualities.

In order to achieve the above objective of the disclosure, the disclosure provides the following technical solution, i.e., the method for the removal of humic acid from the water, including the following steps:

using a peroxymonosulfate (PMS) as an oxidant, using visible light (VI) or ultraviolet light as an activation source, and adding a magnetic ion exchange (MIEX) resin into the water for a reaction.

When the activation source is the visible light, a concentration of the PMS is in a range of 0.625 millimoles per liter (mmol/L) to 5.0 mmol/L.

When the activation source is the visible light, an addition amount of the MIEX resin is in a range of 1.0 milliliters per liter (ml/L) to 4.0 ml/L.

In an embodiment, when the activation source is the visible light, a temperature of the water is in a range of 288 degrees Kelvin (K) to 318 K.

In an embodiment, when the activation source is the ultraviolet light, a concentration of the PMS is in a range of 0.083 mmol/L to 3.32 mmol/L.

In an embodiment, when the activation source is the ultraviolet light, an addition amount of the MIEX resin is in a range of 1.0 ml/L to 4.0 ml/L.

In an embodiment, when the activation source is the ultraviolet light, a temperature of the water is in a range of 283 K to 313 K.

In an embodiment, a time for the reaction is in a range of 90 minutes (min) to 120 min; and a potential of hydrogen value (pH) of the water is in a range of 3 to 11.

Compared with the related art, the disclosure has the following beneficial effects.

The disclosure provides the method for the removal of humic acid from the water. According to the method of the disclosure, the PMS is used as the oxidant, the visible light or the ultraviolet light is used as the activation source, and then the MIEX resin is added into the water for the reaction. By applying the method of the disclosure for the removal of humic acid in the water, irradiated by the visible light, the VI/MIEX/PMS system is coupling to strengthen adsorption process, thereby realizing a relatively high removal effect on the HA; therefore, the VI/MIEX/PMS system can be suitable for a large-scale environment performed by the water treatment, and the removal efficiency thereof on HA can reach about 60% or above. Moreover, irradiated by the ultraviolet light, the UV/MIEX/PMS system can be suitable for small and medium-sized environment performed by rapid water treatment, and can cope with sudden HA pollution of water source in a medium and small range, and the removal efficiency thereof on HA can reach about 90% or above.

### DETAILED DESCRIPTION OF EMBODIMENTS

Various exemplary embodiments of the disclosure are now described in detail, which are not to be considered as a limitation to the disclosure, but are to be understood as a more detailed description of certain aspects, characteristics, and implementation modes of the disclosure.

The disclosure provides a method for a removal of humic acid (HA) from water, including the following steps:

using a peroxymonosulfate (PMS) as an oxidant, using visible light (VI) or ultraviolet light (UV) as an activation source, and adding a magnetic ion exchange (MIEX) resin into the water for a reaction.

In an illustrated embodiment of the disclosure, the PMS is potassium peroxymonosulfate.

In the disclosure, when the activation source is the visible light, a concentration of the PMS is in a range of 0.625 millimoles per liter (mmol/L) to 5.0 mmol/L; and in an illustrated embodiment of the disclosure, the concentration of the PMS is 2.5 mmol/L.

In the disclosure, when the activation source is the visible light, an addition amount of the MIEX resin is in a range of 1.0 milliliters per liter (ml/L) to 4.0 ml/L; and in an illustrated embodiment of the disclosure, the addition amount of the MIEX resin is 2.5 ml/L.

In the disclosure, when the activation source is the visible light, a temperature of the water is in a range of 288 degrees Kelvin (K) to 318 K; and in an illustrated embodiment of the disclosure, the temperature of the water is 318 K.

In the disclosure, when the activation source is the ultraviolet light, a concentration of the PMS is in a range of 0.083 mmol/L to 3.32 mmol/L; and in an illustrated embodiment of the disclosure, the concentration of the PMS is 1.67 mmol/L.

In the disclosure, when the activation source is the ultraviolet light, an addition amount of the MIEX resin is in a range of 1.0 ml/L to 4.0 ml/L; and in an illustrated embodiment of the disclosure, the addition amount of the MIEX resin is 2.5 ml/L.

In the disclosure, when the activation source is the ultraviolet light, a temperature of the water is in a range of 283 K to 313 K; and in an illustrated embodiment of the disclosure, the temperature of the water is 298 K.

In the disclosure, a time for the reaction is in a range of 90 minutes (min) to 120 min; and a potential of hydrogen value (pH) of the water is in a range of 3 to 11.

In an illustrated embodiment of the disclosure, when the activation source is the visible light, the pH value of the water is in a range of 6 to 8, and when the activation source is the ultraviolet light, the pH value of the water is in a range of 6 to 7.

A sulfate anion (SO₄²⁻) is a common inorganic ion, which can be found during the water treatment of drinking water. However, as recited in Standards for drinking water quality (GB5749-2006), a concentration of salt, i.e., containing the SO₄²⁻ (with a unit of mg/L) in the drinking water should be less than or equal to 250. Moreover, when the concentration of SO₄²⁻ is too high, it is possible to cause human diarrhea, dehydration and gastrointestinal disorders. In the reaction system (i.e., VI/MIEX/PMS system or UV/MIEX/PMS system) of the disclosure, the SO₄²⁻ is the primary by-product. In the disclosure, a removal rate of SO₄²⁻ in the process of degrading HA by the VI/MIEX/PMS system reaches 77.83%; and meanwhile, a removal rate of SO₄²⁻ in the process of degrading HA by the UV/MIEX/PMS system reaches 82.62%.

In order to better understand the disclosure, the contents of the disclosure are further described below in connection with the embodiments, but the contents of the disclosure are not limited to the following embodiments.

### Embodiment 1

A concentration of dissolved organic carbon (DOC) is used to characterize the concentration of HA in the solution. In the present embodiment, the concentration of DOC in the solution is determined by a total organic carbon (TOC) analyzer purchased from Japan SHINADZU™ Company, thereby to characterize the HA concentration in the solution. The pH value of the solution is adjusted to about 3.0 before sampling into the analyzer, and then the solution is filtered by using an aqueous filter (referred as to filtering aqueous solution) with an aperture of 0.45 micrometers (μm).

A ratio of a difference-value between an initial HA concentration in solution (C0) and a HA concentration in solution (i.e., HA dissolving in water) at a time point t (Ct) to the initial HA concentration in the solution (C0) is used as an indicator for a removal efficiency of the system, and the removal efficiency is expressed by the following formula a.

$$Removal efficiency = ( C 0 - Ct ) / C 0. \qquad ( formula a )$$

The initial HA concentration (C0) in the solution (i.e., the water) is determined as 20 milligrams per liter (mg/L), the pH value of the solution is adjusted to 7.0, the temperature of the solution is set as 298 K, and then the PMS and the MIEX resin are added into the solution under a condition of visible light with the concentration of the PMS being 2.5 mmol/L and the addition amount of the MIEX resin being 1.0 ml/L, and then the solution added with the PMS and the MIEX resin is stirred uniformly, thereafter performing the reaction on the solution for 90 min, and the HA concentration in the solution at the time point t (Ct) is determined as 7.12 mg/L. Therefore, the removal efficiency of HA is calculated as 64.4%.

### Embodiment 2

Differences between the embodiment 1 and the present embodiment are that the addition amount of the MIEX resin is 2.5 ml/L and the HA concentration in the solution at the time point t (Ct) is determined as 5.67 mg/L. Therefore, the removal efficiency of HA is calculated as 71.65%.

### Embodiment 3

Differences between the embodiment 1 and the present embodiment are that the addition amount of the MIEX resin is 4.0 ml/L and the HA concentration in the solution at the time point t (Ct) is determined as 4.95 mg/L. Therefore, the removal efficiency of HA is calculated as 75.25%.

### Embodiment 4

Differences between the embodiment 2 and the present embodiment are that the concentration of the PMS is 0.625 mmol/L and the HA concentration in the solution at the time point t (Ct) is determined as 6.892 mg/L. Therefore, the removal efficiency of HA is calculated as 65.54%.

### Embodiment 5

Differences between the embodiment 2 and the present embodiment are that the concentration of the PMS is 3.75 mmol/L and the HA concentration in the solution at the time point t (Ct) is determined as 5.09 mg/L. Therefore, the removal efficiency of HA is calculated as 74.55%.

### Embodiment 6

Differences between the embodiment 2 and the present embodiment are that the concentration of the PMS is 5.0 mmol/L and the HA concentration in the solution at the time point t (Ct) is determined as 4.93 mg/L. Therefore, the removal efficiency of HA is calculated as 75.35%.

### Embodiment 7

Differences between the embodiment 2 and the present embodiment are that the pH value of the solution is adjusted to 3 and the HA concentration in the solution at the time point t (Ct) is determined as 3.78 mg/L. Therefore, the removal efficiency of HA is calculated as 81.10%.

### Embodiment 8

Differences between the embodiment 2 and the present embodiment are that the pH value of the solution is adjusted to 11 and the HA concentration in the solution at the time point t (Ct) is determined as 4.97 mg/L. Therefore, the removal efficiency of HA is calculated as 75.15%.

### Embodiment 9

The HA concentration in the solution and the removal efficiency of HA are determined by the same methods as described in the embodiment 1.

The initial HA concentration (C0) in the solution (i.e., the water) is determined as 40 milligrams per liter (mg/L), the pH value of the solution is adjusted to 7.0, the temperature of the solution is set as 298 K, and then the PMS and the MIEX resin are added into the solution under a condition of ultraviolet light with the concentration of the PMS being 1.67 mmol/L and the addition amount of the MIEX resin being 1.0 ml/L, and then the solution added with the PMS and the MIEX resin is stirred uniformly, thereafter performing the reaction on the solution for 120 min, and the HA concentration in the solution at the time point t (Ct) is determined as 4.31 mg/L. Therefore, the removal efficiency of HA is calculated as 89.23%.

### Embodiment 10

Differences between the embodiment 9 and the present embodiment are that the addition amount of the MIEX resin is 2.5 ml/L and the HA concentration in the solution at the time point t (Ct) is determined as 2.48 mg/L. Therefore, the removal efficiency of HA is calculated as 93.80%.

### Embodiment 11

Differences between the embodiment 9 and the present embodiment are that the addition amount of the MIEX resin is 4.0 ml/L and the HA concentration in the solution at the time point t (Ct) is determined as 2.42 mg/L. Therefore, the removal efficiency of HA is calculated as 93.95%.

### Embodiment 12

Differences between the embodiment 9 and the present embodiment are that the concentration of the PMS is 0.83 mmol/L and the HA concentration in the solution at the time point t (Ct) is determined as 3.92 mg/L. Therefore, the removal efficiency of HA is calculated as 90.20%.

### Embodiment 13

Differences between the embodiment 10 and the present embodiment are that the concentration of the PMS is 2.49 mmol/L and the HA concentration in the solution at the time point t (Ct) is determined as 2.87 mg/L. Therefore, the removal efficiency of HA is calculated as 92.83%.

### Embodiment 14

Differences between the embodiment 10 and the present embodiment are that the concentration of the PMS is 3.32 mmol/L and the HA concentration in the solution at the time point t (Ct) is determined as 2.98 mg/L. Therefore, the removal efficiency of HA is calculated as 92.55%.

### Embodiment 15

Differences between the embodiment 10 and the present embodiment are that the pH value of the solution is adjusted to 3 and the HA concentration in the solution at the time point t (Ct) is determined as 2.30 mg/L. Therefore, the removal efficiency of HA is calculated as 94.25%.

### Embodiment 16

Differences between the embodiment 10 and the present embodiment are that the pH value of the solution is adjusted to 9 and the HA concentration in the solution at the time point t (Ct) is determined as 2.57 mg/L. Therefore, the removal efficiency of HA is calculated as 93.58%.

### Embodiment 17

Differences between the embodiment 10 and the present embodiment are that the pH value of the solution is adjusted to 11 and the HA concentration in the solution at the time point t (Ct) is determined as 2.37 mg/L. Therefore, the removal efficiency of HA is calculated as 94.08%.

The above embodiments only express several embodiments of the disclosure, and the description thereof is more specific and detailed, but cannot be understood as a limitation to the scope of the disclosure. It should be noted that, for those skilled in the related art, several variations and improvements can be made without departing from the concept of the disclosure, all of which fall within the scope of the protection of the disclosure. Therefore, the scope of the protection shall be subject to the disclosure.

What is claimed is:

1. A method for a removal of humic acid from water, comprising: using a peroxymonosulfate (PMS) as an oxidant, using visible light as an activation source, and adding a magnetic ion exchange (MIEX) resin into the water for a reaction;
wherein a concentration of the PMS is in a range of 0.625 millimoles per liter (mmol/L) to 5.0 mmol/L; an addition amount of the MIEX resin is in a range of 1.0 milliliters per liter (ml/L) to 4.0 ml/L; and
wherein a potential of hydrogen value (pH) of the water is in a range of 6 to 8.

2. The method as claimed in claim 1, wherein a temperature of the water is in a range of 288 degrees Kelvin (K) to 318 K.

3. The method as claimed in claim 1, wherein a time for the reaction is in a range of 90 minutes (min) to 120 min.
